(19) United States
(12) Patent Application Publication
(10) Pub. No.: US 2006/0291214 A1
(43) Pub. Date: Dec. 28, 2006

(54) Replaceable vehicle lamp with LED light sources

(76) Inventors: Thomas Tessnow, Weare, NH (US); Michael Tucker, Henniker, NH (US); Charles M. Coushaine, Rindge, NH (US)

Correspondence Address: OSRAM SYLVANIA INC, 100 ENDICOTT STREET, DANVERS, MA, 01923, US

(21) Appl. No.: 11/443,834

(22) Filed: May 31, 2006

Related U.S. Application Data
(60) Provisional application No. 60/693,254, filed on Jun. 23, 2005.

(51) Int. Cl. F21V 29/00

(52) U.S. Cl. 362/294

(57) ABSTRACT

An LED light source (10) has a substantially planar housing (12) transversely arrayed about a longitudinal axis (14) and including a through-hole (16) in a first surface (17) thereof. A planar, heat conductive support (18) is positioned with the housing, the planar heat conductive support (18) having a front side (20), a back side (22) and a center point (24) coaxial with said longitudinal axis (14). LEDs (26) are mounted on the front side (20) and are arrayed about the center point (24). A base (28) supports the planar, heat conductive support (18) and is fixed to the housing (12). A heat sink (30) is in thermal contact with the base (28) and extends outwardly of the housing (12). A connector (32) is formed with the housing (12) for receiving electrical input to the LEDs.

### CROSS-REFERENCE TO RELATED APPLICATIONS

The Applicants hereby claim the benefit of their provisional application, Ser. No. 60/693,254 filed Jun. 23, 2005 for REPLACEABLE VEHICLE LAMP WITH LED LIGHT SOURCES.

### TECHNICAL FIELD

The invention relates to electric lamps and particularly to electric lamps with LED light sources. More particularly the invention is concerned with a replaceable vehicle lamp with LED light sources.

### BACKGROUND ART

Currently automotive LED lighting applications use one of several methods. One is to use one or more LEDs arrayed in a specific pattern, for a specific lamp in a specialized module. Each styled lamp is then independently designed for style and optics. Another method is to use one or more LEDs on a bulb with a specific direct radiation pattern for the specific application. For example a headlamp pattern or a taillight pattern may be generated in a standard bulb format. A third technique is to use LED modules or LED bulbs in coordination with a reflector. The standard LED bulb then supplies a standard beam that is specialized by the reflector.

There is a desire for the convenience of LED modules that can be used in many formats, like a standard bulb. At the same time there is a desire to escape the size and look of the lamps that define the final beam pattern with a reflector.

### DISCLOSURE OF INVENTION

Therefore, it is an object of the invention to obviate the disadvantages of the prior art.

It is another object of the invention to enhance LED lamps.

It is yet another object of the invention to particularly enhance automotive LED lighting.

These objects are accomplished, in one aspect of the invention, by an LED light source comprising: a substantially planar housing transversely arrayed about a longitudinal axis and including a through-hole in a first surface Of said palanar housing; a planar, heat conductive support positioned with said housing, said planar heat conductive support having a front side, a back side and a center point coaxial with said longitudinal axis; a plurality of LEDs mounted on said front side and arrayed about said center point; a base supporting said planar, heat conductive support and fixed to said housing; a heat sink in thermal contact with said base and extending outwardly of said housing; and a connector formed with said housing for receiving electrical input to said LEDs.

This light source is replaceable and amenable to the addition of specifically designed optics and lenses to allow customized light outputs and, further, has no need of a reflector.

### BRIEF DESCRIPTION OF THE DRAWINGS

FIG. 1 is plan view of an embodiment of the invention;

FIG. 2 is a plan view of an alternate embodiment of the invention;

FIG. 3 is a cross-sectional view taken along the line 3-3 of FIG. 1;

FIG. 4 is an elevational view of an aspect of the invention; and

FIG. 5 is an elevational view of yet another aspect of the invention.

### BEST MODE FOR CARRYING OUT THE INVENTION

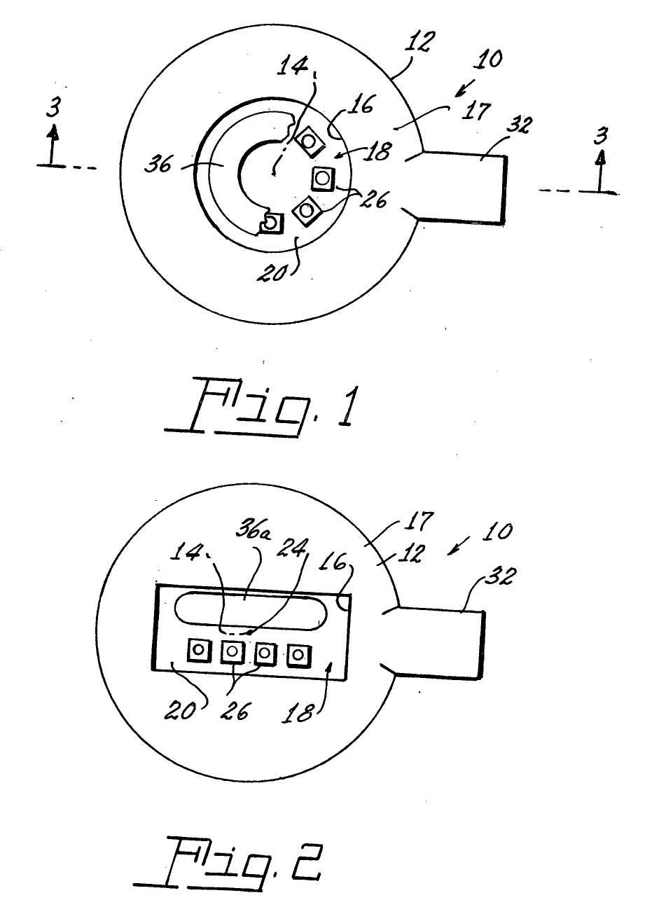

Referring now to the drawings with greater particularity, there is shown in FIG. 1 a replaceable LED lamp assembly 10 comprising a substantially planar housing 12 transversely arrayed about a longitudinal axis 14 and including a through-hole 16 in a first surface 17 thereof. A planar, heat conductive support 18 of a suitable material, such as any metal, with copper or aluminum preferred, or a thermally conductive plastic, is positioned within the housing 12. The planar heat conductive support 18 has a front side 20, a back side 22 and a center point 24 coaxial with the longitudinal axis 14.

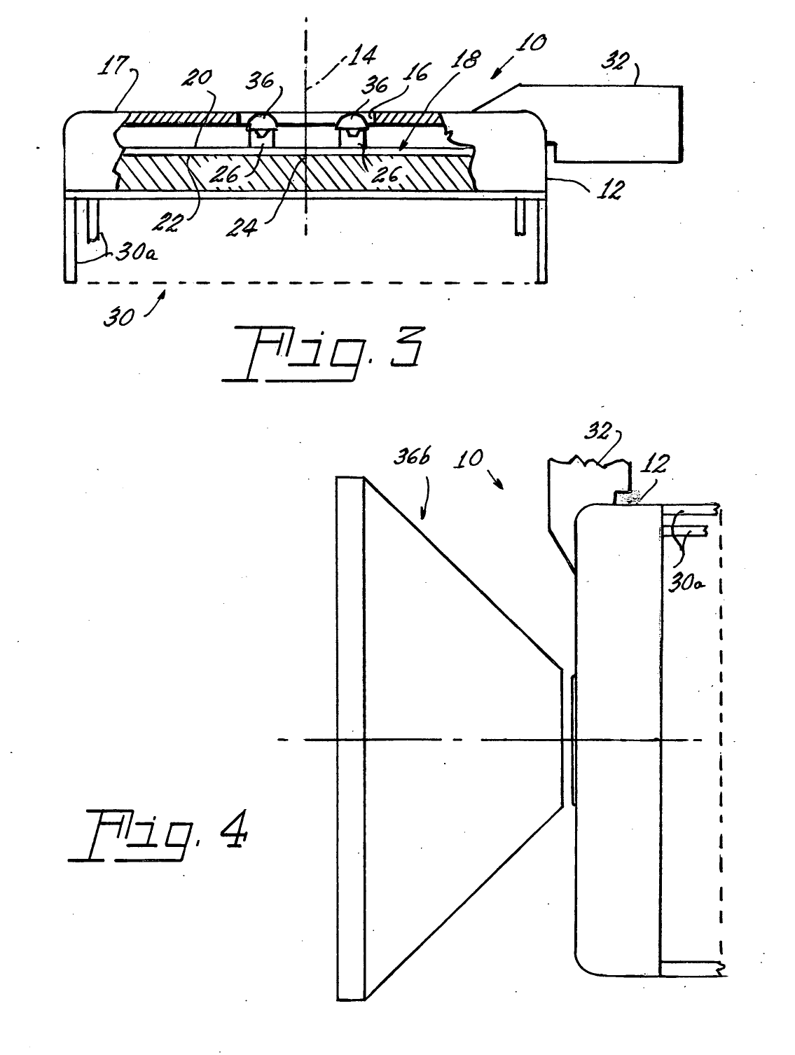

LEDs 26 are mounted on the front side 20 and arrayed about the center point 24. In the embodiment shown in FIG. 1 the array is circular and in the embodiment shown in FIG. 2 the array is linear. In a preferred mode there are eight LEDs 26 in each array; however, the actual number will be dependent upon the end use of the light source and, of course, the light output of the individual LEDs.

A base 28 supports the planar, heat conductive support 18 and is fixed to the housing 12 as desired. Preferably, the base 28 is also thermally conductive so that heat generated by the LEDs during operation is passed through the base 28 to the heat sink 30, which is in thermal contact with the base and extends outwardly of the housing. The heat sink 30 can comprise a number of metal rods 30a, the number varying with the size and power of the light source. In a preferred embodiment the light source housing has a diameter of 2.5 inches and there can be about 100 metal rods. The rods preferably have a length of 0.5 inches. If desired, fins can be utilized in place of the rods 30a. A connector 32 is formed with the housing 12 for receiving electrical input to the LEDs and can contain a plurality of electrical contacts, as is known in the art.

The light source 10 described above can be considered to be a complete unit; however, additional modifications can be made to improve its public reception.

For example, couplers 34 can be provided on the surface 17 to ease the mounting requirements when the light source 10 is coupled to a receptive body. In a preferred embodiment the couplers are suitable for rotational coupling.

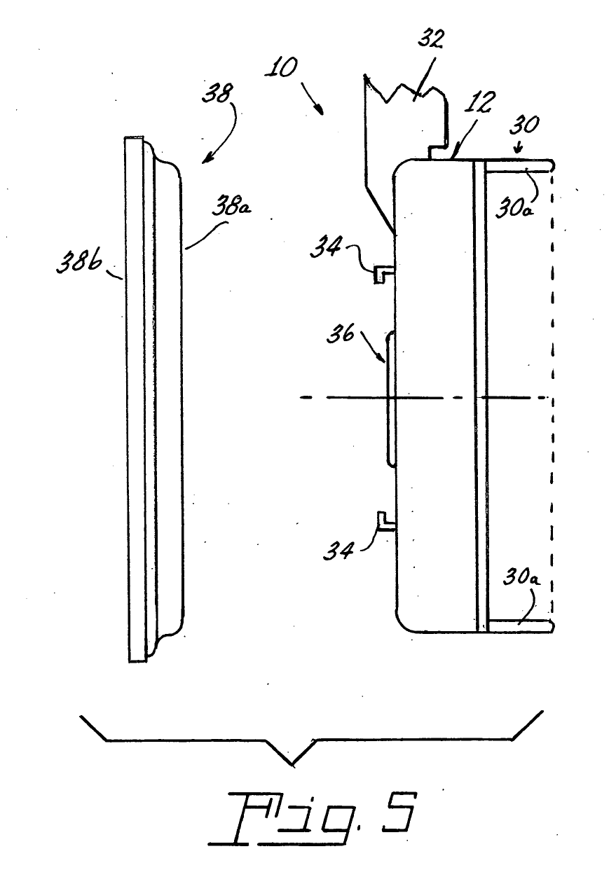

Primary optics can be provided. For example, in FIGS. 1, 2 and 3 a primary optic 36 (in the case of the circular array of FIGS. 1 and 3) or 36a (in the case of the linear array of FIG. 2) can be bonded directly to the LEDs 26 by means of an optical cement. Alterantively, a large conical optic 36b, such as shown in FIG. 4 can be utilized.

Ideally, however, the light source 10 would be provided with perhaps the primary optic 36 and then used in conjunction with a secondary optic 38 specifically designed by a customer to achieve an individual result. For example, the secondary optic could include a Fresnel optic or lens 38a on one side of the optic and a pillow or other lens type 38b on the other.

The circuitry, preferably in the form of a printed circuit, can be provided upon the planar, heat conductive support 18 to help achieve the compactness necessary for light source to be practical.

Thus, this light source provides a replacement light source that can be employed with many differing lens arrangements.

While there have been shown and described what are at present considered to be the preferred embodiments of the invention, it will be apparent to those skilled in the art that various changes and modifications can be made herein without departing from the scope of the invention as defined by the appended claims.

What is claimed is:

1. An LED light source comprising:
a substantially planar housing transversely arrayed about a longitudinal axis and including a through-hole in a first surface thereof;
a planar, heat conductive support positioned with said housing, said planar heat conductive support having a front side, a back side and a center point coaxial with said longitudinal axis;
a plurality of LEDs mounted on said front side and arrayed about said center point;
a base supporting said planar, heat conductive support and fixed to said housing;
a heat sink in thermal contact with said base and extending outwardly of said housing; and
a connector formed with said housing for receiving electrical input to said LEDs.

2. The LED light source of claim 1 wherein said plurality of LEDs is circularly arrayed.

3. The LED light source of claim 1 wherein said plurality of LEDs is linearly arrayed.

4. The LED light source of claim 1 wherein said connector extends transversely away from said longitudinal axis.

5. The LED light source of claim 1 wherein said housing includes couplers for mounting said light source.

6. The LED light source of claim 5 wherein said couplers enable rotational mounting.

7. The LED light source of claim 1 wherein said housing includes circuitry for regulating the output of said LEDs.

8. The LED light source of claim 7 wherein said circuitry is associated with said planar, heat conductive support.

9. The LED light source of claim 1 wherein a primary optic covers said plurality of LEDs.

10. The LED light source of claim 1 wherein multiple optics are associated with said LEDs.

11. In combination, an LED light source comprising:
a substantially planar housing transversely arrayed about a longitudinal axis and including a through-hole in a first surface thereof;
a planar, heat conductive support positioned with said housing, said planar heat conductive support having a front side, a back side and a center point coaxial with said longitudinal axis;
a plurality of LEDs mounted on said front side and arrayed about said center point;
a base supporting said planar, heat conductive support and fixed to said housing;
a heat sink in thermal contact with said base and extending outwardly of said housing;
a connector formed with said housing for receiving electrical input to said LEDs;
a primary optic fitted to said plurality of LEDs; and
a secondary optic spaced from said primary optic for modifying the light output of said plurality of LEDs to provide a desired pattern.

12. The LED light source 10 of claim 1 or 11 wherein said heat sink 30 comprises a plurality of metal fingers 30a extending away from said base 28
